(19) United States
(12) Patent Application Publication
(10) Pub. No.: US 2007/0124197 A1
(43) Pub. Date: May 31, 2007

(54) System, method and computer readable medium for billing

(75) Inventors: Benjamin P. Robinson, Plano, TX (US); Debbie Lemon, Carrollton, TX (US); Sarath Karthik Balachandran, Irving, TX (US)

Correspondence Address: WINSTEAD SECHREST & MINICK P.C., P.O. BOX 50784, DALLAS, TX, 75201, US

(73) Assignee: Rent-A-Toll, Ltd., Plano, TX (US)

(21) Appl. No.: 11/516,376

(22) Filed: Sep. 6, 2006

Related U.S. Application Data
(60) Provisional application No. 60/714,716, filed on Sep. 7, 2005.

(51) Int. Cl. G07B 15/00; G07B 15/02

(52) U.S. Cl. 705/13

(57) ABSTRACT

A system, method, and computer readable medium for billing comprises receiving, by a toll authority, data related to a tracking device coupled to a rented transport, contemporaneously receiving, by the device from the toll authority, information including at least one of: a direction of travel by the transport, a location of the transport, a price of the toll, a toll gate number, a date, and a time, reading the received information by a reader, sending the read information to a database, matching the sent information with information related to a rental agreement, wherein the rental agreement covers the rented transport, and determining a billing amount based on the matched information

### CROSS-REFERENCE TO RELATED APPLICATIONS

The present patent application claims priority from U.S. Provisional Patent Application No. 60/714,716, titled Toll Fee System And Method, filed on Sep. 7, 2005, the entire contents of which is incorporated by reference herein.

The present patent application is also related to U.S. Non-Provisional patent application Ser. No. 11/125,521, titled Toll Fee System And Method, filed on May 10, 2005, and to U.S. Non-Provisional Patent Application Docket No. RTL009, titled System, Method, And Computer Readable Medium For Billing Tolls, filed on even date herewith, the entire contents of each of which are incorporated by reference herein.

### BACKGROUND OF THE INVENTION

The present invention relates generally to toll fee tracking systems and methods and, more particularly, but not by way of limitation, to toll fee tracking systems and methods for automatic, non-contact, high-speed toll fee tracking of vehicular tolls associated with a toll tracking device used by vehicle operators. Further, the present invention relates to systems, methods, and computer readable media for billing.

### BRIEF SUMMARY OF THE INVENTION

A toll fee tracking system comprising a toll authority, a toll fee tracking device installed within the vehicle, a toll rental entity, and a third party entity. The toll fee tracking device is adapted to wirelessly receive the toll usage information which is then stored within the device. When the vehicle is returned to the third party entity, the toll usage data is retrieved from the toll fee tracking device so that immediate billing may be initiated by the third party entity.

In one embodiment of the present invention, a method for billing comprises receiving, by a toll authority, data related to a tracking device coupled to a rented transport, contemporaneously receiving, by the device from the toll authority, information including at least one of: a direction of travel by the transport, a location of the transport, a price of the toll, a toll gate number, a date, and a time, reading the received information by a reader, sending the read information to a database, matching the sent information with information related to a rental agreement, wherein the rental agreement covers the rented transport, and determining a billing amount based on the matched information.

In another embodiment of the present invention, a computer readable medium comprises instructions for receiving, by a first system, data related to a rented transport that includes a tracking device, receiving, by the device from the first system, toll usage information, receiving, by a second system from the device, the toll usage information, and generating a bill based on the toll usage information.

In a further embodiment of the present invention, a system for billing comprises a third party entity, a toll rental entity that receives a request for service from the third party entity, wherein the request includes at least one of: a toll fee device identifier, a start date of the service, a start time of the service, an end date of the service, an end time of the service, and a toll authority that receives a payment from the toll rental entity for the service.

In yet another embodiment of the present invention, a system for billing comprises a third party entity, a toll fee device that receives a request for service from the third party entity, wherein the request includes at least one of: a toll fee device identifier, a start date of the service, a start time of the service, an end date of the service, an end time of the service, and a toll data database communicably coupled to the toll fee device, wherein the toll data database is refreshed upon receipt of the request.

In yet a further embodiment of the present invention, a method for billing comprises receiving information including at least one of: a direction of travel by a transport, a location of the transport, a price of a toll, a toll gate number, a date, and a time, sending the received information to a database, matching the sent information with information related to a rental agreement, wherein the information related to the rental agreement is stored in the database, and wherein the rental agreement covers the rented transport, and determining a billing amount based on the matched information.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a block diagram of a system in accordance with an embodiment of the present invention;

FIG. 2 illustrates a toll fee tracking device installed within a vehicle;

FIG. 3 is a block diagram of a system in accordance with an embodiment of the present invention;

FIG. 4 is a block diagram illustrating the connection between various components of a system in accordance with an embodiment of the present invention;

FIG. 5 is a message flow diagram illustrating a rental vehicle component update in accordance with an embodiment of the present invention;

FIG. 6 is a message flow diagram illustrating rental service request processing in accordance with an embodiment of the present invention;

FIG. 7 is a block diagram of a system in accordance with an embodiment of the present invention;

FIG. 8 is a flow chart of sending a service request in accordance with an embodiment of the present invention;

FIG. 9 is a flow chart of sending toll data in accordance with an embodiment of the present invention;

FIG. 10 is a block diagram of a system in accordance with an embodiment of the present invention;

FIG. 11 is a process flow diagram of a toll fee device in accordance with an embodiment of the present invention; and

FIG. 12 is a flow chart of a toll fee device life cycle in accordance with an embodiment of the present invention.

### DETAILED DESCRIPTION OF THE INVENTION

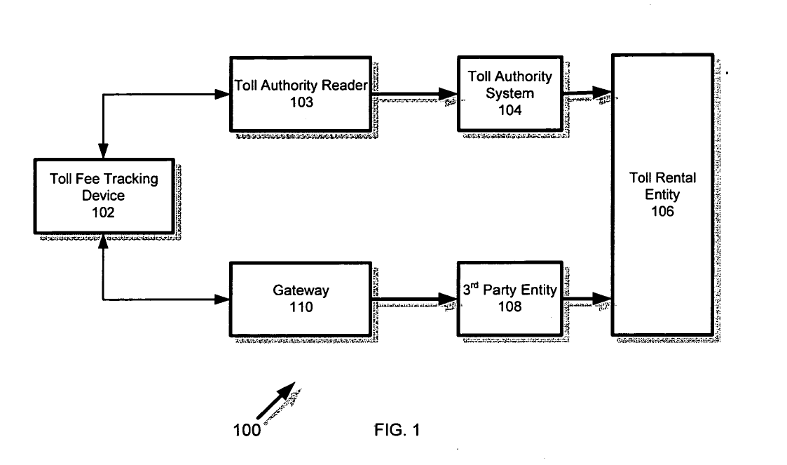

Referring now to FIG. 1, a block diagram of a system 100 is illustrated. The toll fee tracking device 102 is a hardware/software component used to store toll usage of a vehicle. In other embodiments, the toll fee tracking device 102 may be a hardware component, a software component, a firmware component or a combination of either or all of these components, and may be used to store toll usage of a vehicle, other information about the vehicle or a driver or the vehicle, and/or to transmit such usage or information. The toll fee tracking device 102 is installed in the vehicles associated with toll rental entity 106 for toll collection. The toll fee tracking device uses wireless technology such as, but not limited to, radio frequency to communicate with toll authority 104.

One embodiment of the toll fee tracking device 102 comprises the following features and functionalities:
The toll fee tracking device 102 can read, write, and/or send vehicle toll usage data to toll systems 104 and third party entities 108.
The toll fee tracking device 102 can be read and write RFID transponders.
The toll fee tracking device 102 is adapted to support wireless technology such as Radio Frequency (RF) to communicate with the toll authorities 104 and third party entity systems 108 that are a part of the third party entities 108.
The toll fee tracking device 102 is adapted to store toll usage data.
The toll fee tracking device 102 is adapted to support high-speed vehicle traffic in the highways to communicate with toll authorities 104.
The toll fee tracking device 102 is adapted to support long-range wireless communication such as, for example, 1000-foot range.

The system of FIG. 1 includes a toll authority 104. The toll authority reader 103 is adapted to detect vehicles coming in the toll authority 104. The toll authority 104 is further adapted to authenticate the vehicles that are associated with the toll rental entity 106. Once the vehicles are authenticated, the toll authority reader 103 writes the toll usage to the toll fee tracking device 102 with information, such as, for example, toll gate information, date, direction, etc. This information is stored within the toll fee tracking device 102. In other embodiments, the toll fee tracking device 102 can receive information, such as the toll usage, information related to a transport, information related to a license plate of the transport, a location of the transport, a direction of the transport, a time stamp related to the transport, and a toll amount incurred by the transport, from at least one of the depicted elements.

The system further includes a toll fee tracking device 102 which is adapted to identify rental vehicle and store its toll usage for billing vehicle users at a later time. A toll system 104 receives toll usage data from the toll authority reader 103 for verification and system integration with toll rental entity 106. A gateway 110 communicates with the toll fee tracking device 102 using wireless technology such as, for example, radio frequency (RF), 802.11, 802.16, UWB, satellite, and the like. The gateway 110 ties into a LAN or WAN (not shown) using wired or wireless setup to communicate with a third party entity 108. When the user returns the vehicle to the third party entity 108, the gateway 110 collects the toll usage from the toll fee tracking device 102 and updates the third party entity system for billing. The toll rental entity 106 provides a common platform to connect both the third party entity 108 and the toll authority 104 using the toll fee tracking device 102. This allows any third party entity to work with any toll authority 104. In other embodiments, the gateway 110 or any other depicted element can collect the toll usage and/or send information to the toll fee tracking device 102 before and/or after the vehicle arrives at the third party entity 108. In further embodiments, the toll authority reader 103 and/or the gateway 110 may be directly connected to the toll rental entity. Also, any of the depicted elements may be directly connected to each other and may send and/or receive information to and from each other without departing from the scope of the present invention. Further, any of the functionality performed by one of the entities may be performed by at least another one of the entities.

Once the vehicle is authenticated, the toll authority 104 should be able to write the toll usage into the toll fee tracking device 102 within a short period of time, for example, nanoseconds. In other embodiments, the toll authority 104 is able to write the toll usage into the toll fee tracking device 102 within a longer period of time.

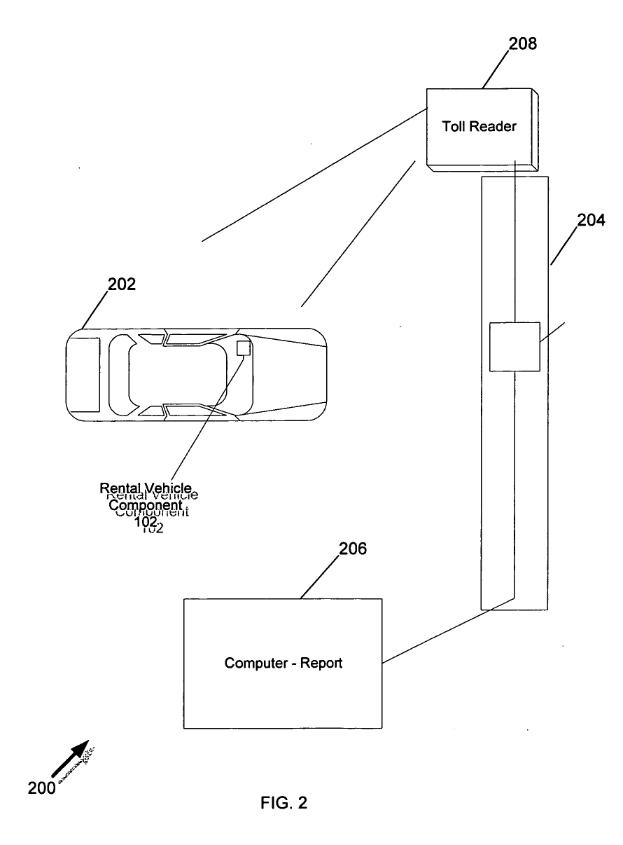

Referring now to FIG. 2, a system 200 including a toll fee tracking device, or a rental vehicle component (RVC) 102 installed within a vehicle 202 is illustrated. Third party entities will use the toll fee tracking device 102 in their vehicles. Each toll fee tracking device 102 is identified by a unique identification referred to as a vehicle ID. This vehicle ID may be used as a common reference between the toll authority and the third party entity. When a vehicle with the toll fee tracking device 102 passes a gate 204 of the toll authority, or at any other time, the toll authority system captures transaction details in a computer 206 via a toll reader 208. If the vehicle ID is associated with a toll rental entity account, information such as, for example, toll fee device ID, location information, time stamp, and transaction description may be passed form toll authority to the toll fee tracking device 102 in order to invoice the user through the third party entity point of sale terminal or system. The toll authority sends the transaction details to the third party entity using the toll fee tracking device 102. In other embodiments, the toll authority sends information, such as the transaction details, to the toll fee tracking device 102 which forwards this information to the third party entity via the toll rental entity. In further embodiments, the information can be sent directly to one or more of these elements or via another entity such as a gateway or other interface.

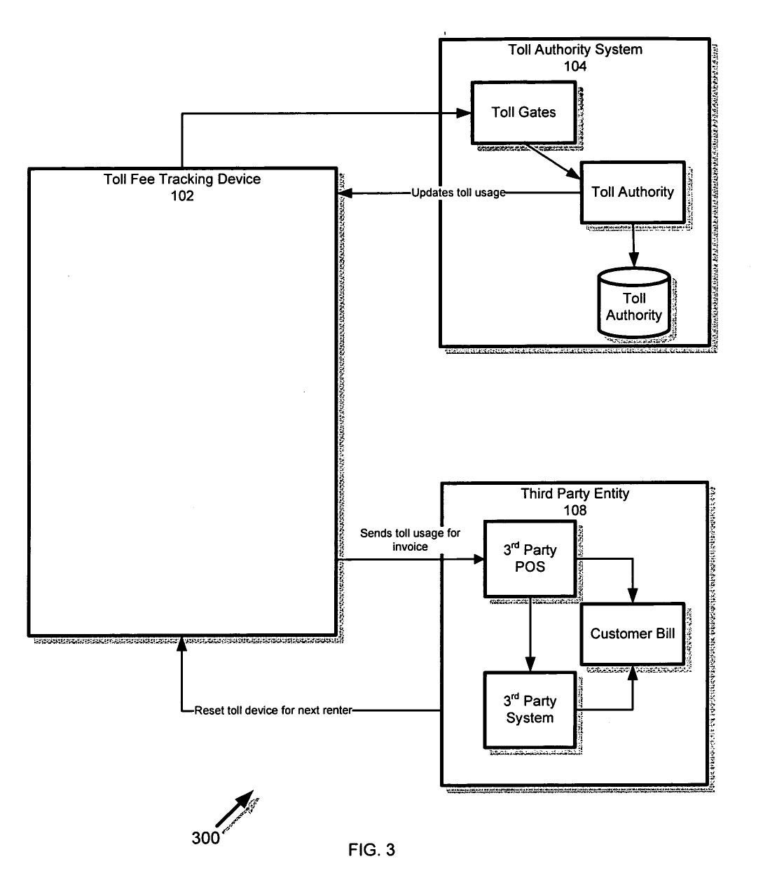

FIG. 3 illustrates a block diagram of a system 300 in accordance with an embodiment of the present invention. The system 300 includes a toll fee tracking device 102, a toll authority system 104 (which includes toll gates, toll authority readers, and toll authority databases, and computers), and a third party entity 108 (which includes a point of sale (POS) terminal or software and a system that generates a customer bill).

Utilizing the system 300, a computer readable medium, or software, of the present invention comprises instructions for receiving, by a first system (for example, the toll authority system 104), data related to a rented transport that includes a tracking device, receiving, by the device 102 from the first system, toll usage information, receiving, by a second system (for example the third party entity 108) from the device, the toll usage information, and generating a bill based on the toll usage information. The computer readable medium further comprises instructions for resetting, by the second system, the tracking device, wherein the resetting occurs when at least one of a following action occurs: the generating of the bill, the receiving of the toll usage information by the second system, the receiving of the toll usage information by the tracking device, an input or an output by the first system, an input or an output by the tracking device, and an input or an output by the second system. In other embodiments, the computer readable medium comprises instructions for generating the bill based on terms of a rental agreement associated with the rented transport or based on a location of the rented transport. In other embodiments, the toll fee tracking device may include or be able to access at least one storage mechanism (such as a database) and at least one processor to perform various actions. In further embodiments, the elements shown can communicate with like elements. For example, two or more toll fee tracking devices can communicate with one another and with the remaining elements in the system.

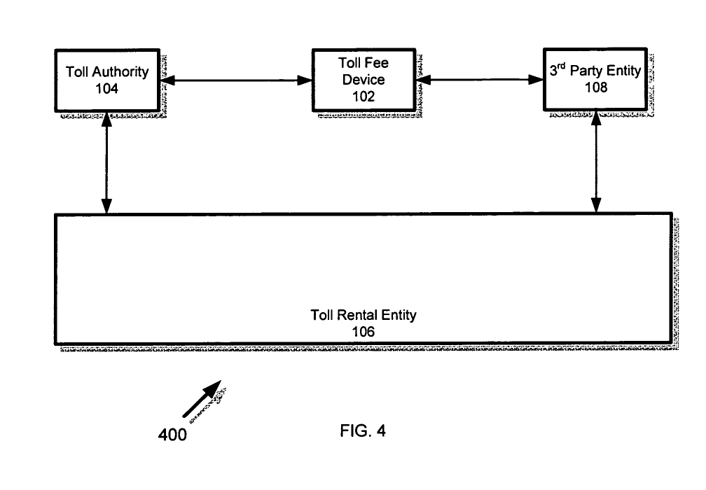

FIG. 4 further illustrates the connection between various components of a system 400 of the present invention. When a user (not shown) returns a vehicle to the third party entity 108, the third party entity system checks for any toll transaction in the toll fee tracking device 102 incurred with the toll authority 104. If there is any toll data stored in the toll fee tracking device 102, the third party entity 108 charges the user the toll usage along with the vehicle rental bill. In other embodiments, the usage of the toll fee tracking device 102 and/or the toll usage is charged to the user by the third party entity 108, or any of the other depicted elements. In further elements, payments, toll usage data and/or toll rental data can be transferred between one or more of the depicted elements.

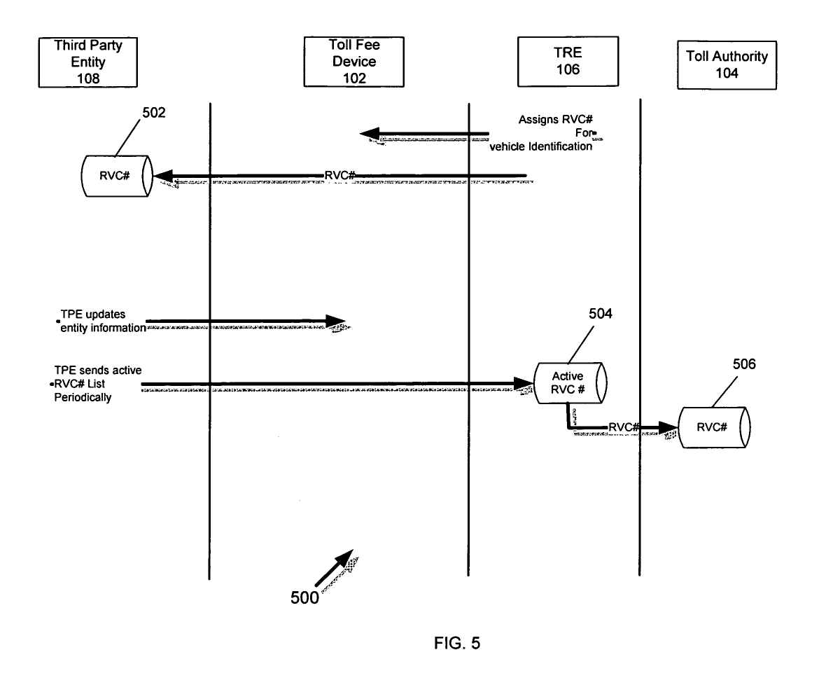

Referring now to FIG. 5 a rental vehicle component (RVC) or toll fee device update message flow 500 is depicted. A toll rental entity 106 assigns an RVC number (or other identifier) to a toll fee device 102 in order to identify a transport such as a vehicle. The toll rental entity 106 then sends the assigned RVC number to a third party entity 108 which updates a RVC database 502. In other embodiments, the toll rental entity 106 can send the assigned RVC number to the third party entity 108 at the same time, or in near-real-time, as the RVC number is assigned to the toll fee device 102. In further embodiments, the same message can send the RVC number to the toll fee device 102 and/or to the third party entity 108.

The third party entity 108 then updates the toll fee device 102 (based on an identifier of the toll fee device 102) with information about the third party entity, an owner of the toll fee device, an owner of the transport and/or a driver of the transport, and sends the toll rental entity 106 an active RVC number list which is stored in a database 504. The toll rental entity 106 then authenticates or validates the toll fee device 102 and/or the transport and to ensure the toll fee device 102 is in a proper state. The list is then sent from the toll rental entity 106 to a toll authority 104 and stored in a database 506 where the RVC numbers are updated. In alternate embodiments of the present invention, the information sent by any of the depicted elements do not have to be stored before being sent to any of the depicted elements. Further, a lesser or greater number of databases, or other storage devices, can be utilized by one or more of the depicted elements in order to store the aforementioned RVC information.

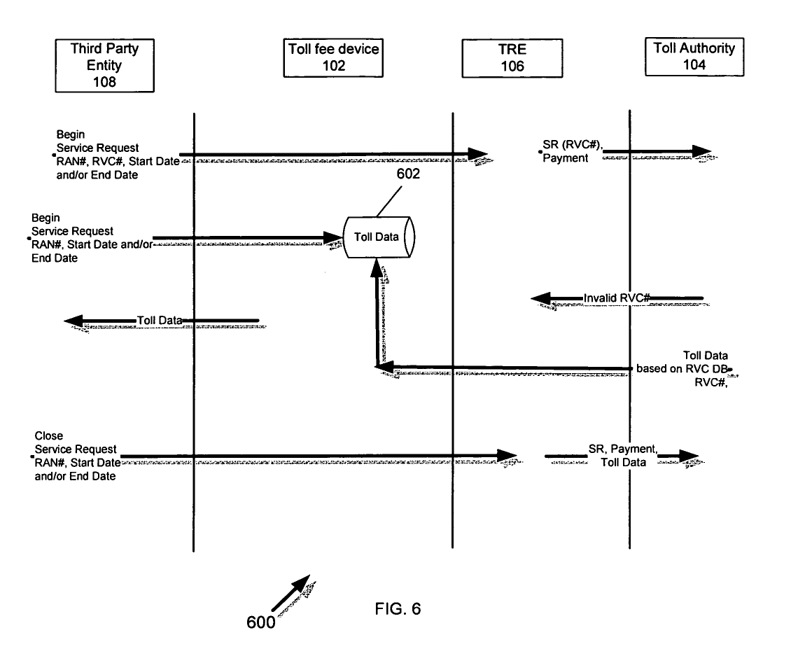

Referring now to FIG. 6, a message flow diagram 600 illustrating rental service request processing and billing is depicted. In the diagram 600, a toll rental entity 106 receives a request for service from a third party entity 108, wherein the request includes at least one of: a rental agreement number (RAN), an RVC number or a toll fee device identifier, a start date of the service, a start time of the service, an end date of the service, and an end time of the service. A toll authority 104 receives a payment from the toll rental entity 106 for the service and receives the request for the service.

In one embodiment, which may occur at the same time as or which may follow the toll authority 104 receiving a payment from the toll rental entity 106 for the service and the request for the service, a system for billing comprises a third party entity 108, a toll fee device (or an RVC) 102 that receives a request for service from the third party entity, wherein the request includes at least one of: a RAN, an RVC number or a toll fee device identifier, a start date of the service, a start time of the service, an end date of the service, and an end time of the service. The system includes a toll data database (or other storage device) 602 communicably coupled (internally and/or externally) to the toll fee device, wherein the toll data database is refreshed (and potentially stored) upon receipt of the request, wherein the third party entity 108 receives toll data from the toll data database in order to apply service fees to the toll data and provide billing to the user or other entity. Further, the third party entity 108 may retain the toll date to determine if a user is in violation of use of the toll service.

The system also comprises a toll rental entity 108 which may receive an invalid RVC number from the toll authority 104. The toll rental entity 108 then checks the database 504 and/or the database 502 (see FIG. 5) for valid RVC numbers. If the valid numbers are not found, the toll rental entity 108 informs the toll authority 104 that checks other sources (such as other toll authorities or systems) to determine an owner, originator, or account holder of the toll fee device 102. The toll data database 602 receives toll data from the toll authority 104 based on the toll fee device database 602 and saves the toll data. Other elements can access or receive information from the toll fee device database 602 for billing and/or payment requests. The third party entity 108 receives the toll data from the toll data database 602 and sends, to the toll rental entity 108, the request including the RAN number, the start date and the end date (in other embodiments the RVC number, the start time and/or the end time can also be sent). The toll authority 104 then receives, from the toll rental entity 106, at least one of: a payment, the request, and the toll data. Although depicted in a particular manner, the messages can be sent to and from any of the shown elements without departing from the scope of the present invention.

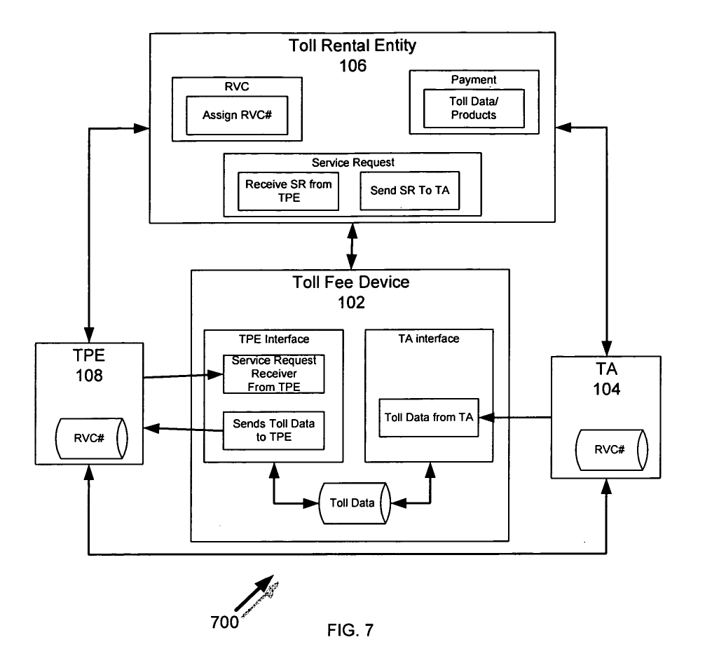

FIG. 7 is a block diagram of a system 700 of the present invention. The system 700 includes a toll fee device 102, a toll authority 104, a toll rental entity 106, and a third party entity 108 which may be wired and/or wirelessly coupled to one another. An RVC module assigns an RVC number to a toll fee device and transmits the assignment to the third party entity 108. A service request is received from the third party entity 108 at a service request module and is sent to the toll fee device (via a third party entity interface) and/or to the toll authority 104. The toll authority writes toll data to the toll fee device 102 (via a toll authority interface). The toll data is then sent to the toll rental entity 106 and to the third party entity 108. The toll rental entity 106 then pays the toll authority 104 from a payment module based on the toll data. The toll rental entity 106 then, or contemporaneously (or near-contemporaneously) receives payment from the third party entity. In other embodiments, one or more of the depicted elements can perform one or more of the aforementioned actions.

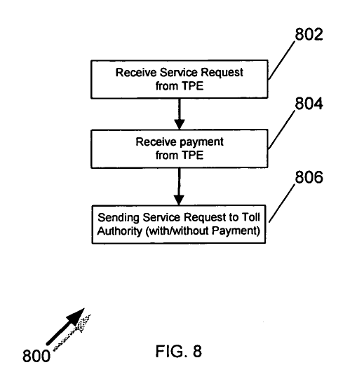

FIG. 8 is a flow chart 800 of sending a service request. At step 802 a service request is received from a third party entity, at step 804 a payment is received from the third party entity, and at step 806 a service request is sent to a toll authority with or without payment.

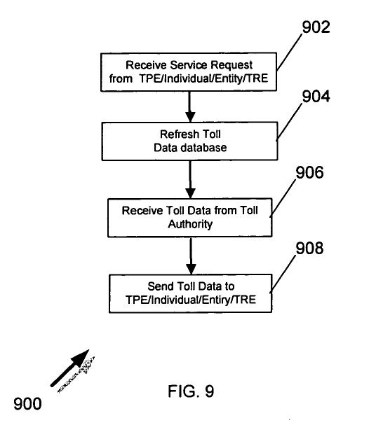

FIG. 9 is a flow chart 900 of sending toll data in relation to a service request. At step 902, a service request is received from a third party entity, an individual, a toll rental entity, or another entity. A toll data database is refreshed at step 904 and toll data is received from a toll authority at step 906. At step 908, toll data is sent to the third party entity, an individual, a toll rental entity, or another entity.

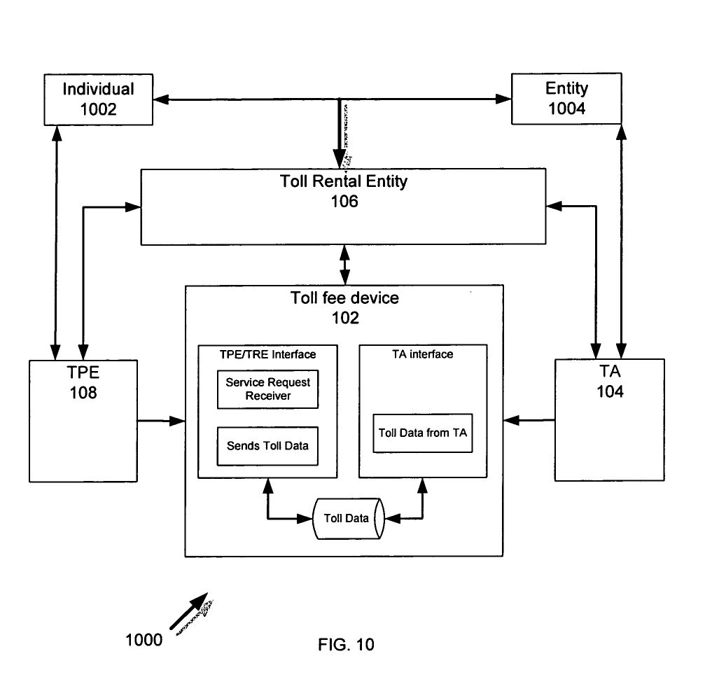

FIG. 10 is a block diagram of a system 1000 of the present invention. The system 1000 includes a toll fee device 102, a toll authority 104, a toll rental entity 106, a third party entity 108, an individual 1002, and another entity 1004 (that may be a similar or a different entity to one or more of the depicted elements) which may be wired and/or wirelessly coupled to one another. The system operates similarly to the system 700 and includes the individual 1002 and the entity 1004 that can communicate with the elements and perform similar actions as described in FIG. 7. In other embodiments, one or more of the depicted elements can perform the aforementioned actions.

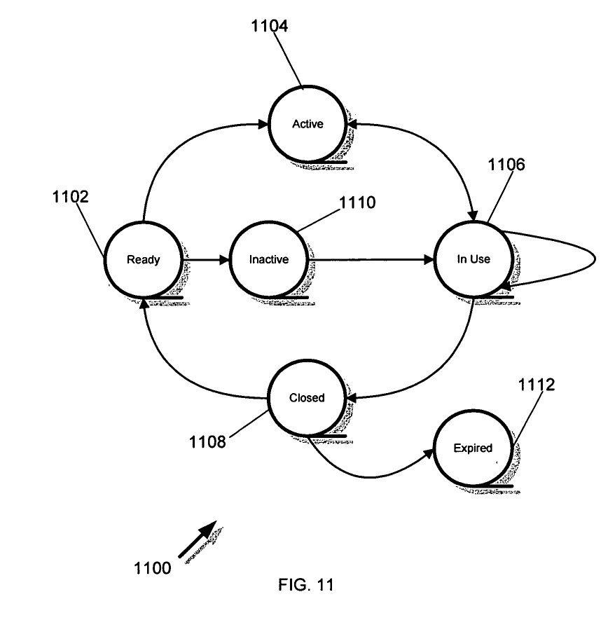

FIG. 11 is a process flow diagram 1100 depicting a life cycle of a single service request of a toll fee device (not shown). The toll fee device experiences the following states: ready 1102 (when the toll fee device is awaiting a service request), active 1104 (when the toll fee device has received a service request), in use 1106 (which may be a semi-persistent state, when it passes a first toll gate), and closed 1108 (when the service request ends or when the transport is returned). At the closed state 1108, the toll fee device can go into an expired state 1112 (when the toll fee device is defective, broken, out of service, etc.). From the inactive state 1110, the toll fee device can return to the in use state 1106 (when the service request is denied but the toll fee device is used at a first toll gate). In other embodiments, fewer states or additional states can be used and multiple service requests can be received for the toll fee device without departing from the scope of the present invention. More specifically, a second service request can be received in which case the toll fee device becomes active 1104 and in use 1106 for the second service request.

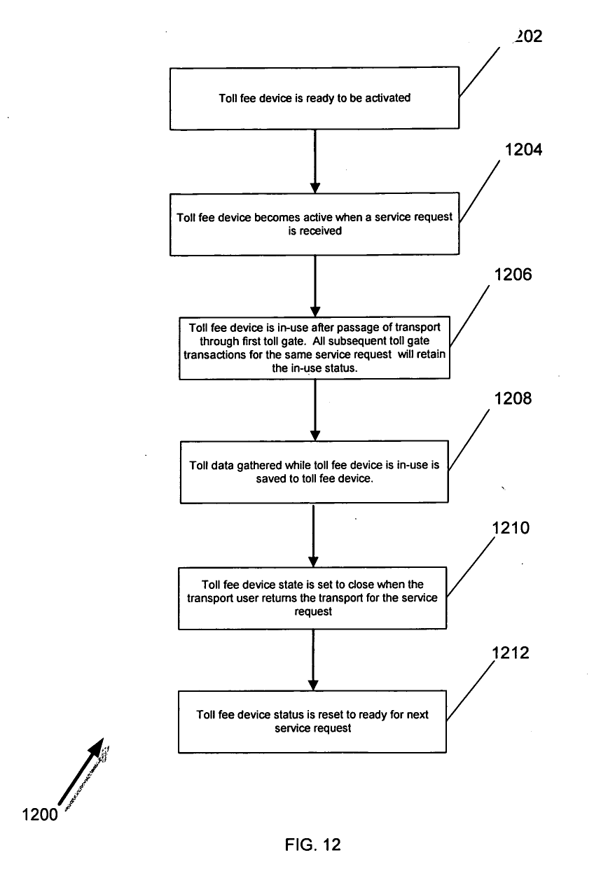

FIG. 12 is a flow chart 1200 of a toll fee device life cycle. At step 1202, the toll fee device is ready to be activated, at step 1204 the toll fee device becomes active when a service request is received, and at step 1206, the toll fee device is in-use after passage of the transport through a first toll gate. All subsequent toll gate transactions for the same service request will retain the in-use status. At step 1208, the toll data gathered while the toll fee device is in-use is saved to a toll fee device whose state is set to close when the transport user returns the transport for the service request at step 1210. The toll fee device status is reset to ready for a next service request at step 1212. In other embodiments, the toll fee device may not be reset to ready because multiple users and/or service requests may be active.

In one embodiment of the present invention, a method for billing comprises receiving, by a toll authority (or a toll authority system) data related to a tracking device coupled to a transport (which may be owned or rented), contemporaneously (or near-contemporaneously) receiving, by the device from the toll authority, information including at least one of: a direction of travel by the transport, a location of the transport, a price of the toll, a toll gate number, a date, and a time, reading the received information by a reader, sending the read information to a database, matching the sent information with information related to a rental agreement, wherein the rental agreement covers the rented transport, and determining a billing amount based on the matched information.

The method further comprises receiving the billing amount by a third party entity that initiated the rental agreement, modifying the billing amount by the third party entity (for example, increasing the billing amount to account for added services or lengths of service, or decreasing the billing amount based on promotions) and sending the modified billing amount to at least one of: an individual operating the transport, an individual renting the transport, an entity renting the transport, and an entity employing the individual. The method also comprises storing, by the toll authority, the received data, sending, by the toll authority to a toll rental entity, at least one of: the received data and the stored data, matching, by the toll rental entity, the at least one of the received data and the stored data with information received from a third party entity, determining a billing amount based on the matched information by the toll rental entity, and sending the billing amount by the toll rental entity to at least one of: an individual operating the transport, an individual renting the transport, an entity renting the transport, and an entity employing the individual.

The method further comprises sending the billing amount by the toll rental entity to a third party entity that initiated the rental agreement, modifying the billing amount by the third party entity, and sending the modified billing amount to at least one of: an individual operating the transport, an individual renting the transport, an entity renting the transport, and an entity employing the individual, wherein the tracking device is coupled to the individual, wherein the tracking device is integrated with an electronic device belonging to the individual, and wherein the transport is at least one of: a car, truck, a motorcycle, a boat, a train, a plane, and a bicycle.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the described or depicted elements. Also, these capabilities may be performed in the current manner or in a distributed manner and on, or via, any device able to provide and/or receive information. Further, although depicted in a particular manner, various modules or blocks may be repositioned without departing from the scope of the current invention. For example, information being sent to the toll rental entity can be sent to the third party entity or to multiple third party entities or may be sent to one of the entities in lieu of the other. Still further, although depicted in a particular manner, a greater or lesser number of elements and connections can be utilized with the present invention in order to accomplish the present invention, to provide additional known features to the present invention, and/or to make the present invention more efficient. For example, a cellular phone, RFID chip or other electronic device can be used to send, receive, and/or store any of the data described or depicted herein. Also, the information sent between various elements described or depicted herein, can be sent via a wireless source and/or a wired source and via a plurality of protocols.

What is claimed is:

1. A method for billing, comprising:
receiving, by a toll authority, data related to a tracking device coupled to a rented transport;
contemporaneously receiving, by the device from the toll authority, information including at least one of: a direction of travel by the transport, a location of the transport, a price of the toll, a toll gate number, a date, and a time;
reading the received information by a reader;
sending the read information to a database;
matching the sent information with information related to a rental agreement, wherein the rental agreement covers the rented transport; and
determining a billing amount based on the matched information.

2. The method of claim 1 comprising receiving the billing amount by a third party entity that initiated the rental agreement.

3. The method of claim 2 comprising modifying the billing amount by the third party entity.

4. The method of claim 3 comprising sending the modified billing amount to at least one of:
an individual operating the transport;
an individual renting the transport;
an entity renting the transport; and
an entity employing the individual.

5. The method of claim 1 comprising storing, by the toll authority, the received data.

6. The method of claim 5 comprising sending, by the toll authority to a toll rental entity, at least one of:
the received data; and
the stored data.

7. The method of claim 6 comprising matching, by the toll rental entity, the at least one of the received data and the stored data with information received from a third party entity.

8. The method of claim 7 comprising determining a billing amount based on the matched information by the toll rental entity.

9. The method of claim 8 comprising sending the billing amount by the toll rental entity to at least one of:
an individual operating the transport;
an individual renting the transport;
an entity renting the transport; and
an entity employing the individual.

10. The method of claim 8 comprising sending the billing amount by the toll rental entity to a third party entity that initiated the rental agreement.

11. The method of claim 10 comprising modifying the billing amount by the third party entity.

12. The method of claim 11 comprising sending the modified billing amount to at least one of:
an individual operating the transport;
an individual renting the transport;
an entity renting the transport; and
an entity employing the individual.

13. The method of claim 1, wherein the tracking device is coupled to the individual.

14. The method of claim 1, wherein the tracking device is integrated with an electronic device belonging to the individual.

15. The method of claim 1, wherein the transport is at least one of:
a car, truck, a motorcycle, a boat, a train, a plane, and a bicycle.

16. A computer readable medium comprising instructions for:
receiving, by a first system, data related to a rented transport that includes a tracking device;
receiving, by the device from the first system, toll usage information;
receiving, by a second system from the device, the toll usage information; and
generating a bill based on the toll usage information.

17. The computer readable medium of claim 16 comprising instructions for resetting, by the second system, the tracking device.

18. The computer readable medium of claim 17, wherein the resetting occurs when at least one of a following action occurs:
the generating of the bill;
the receiving of the toll usage information by the second system;
the receiving of the toll usage information by the tracking device;
an input by the first system;
an output by the first system;
an input by the tracking device;
an output by the tracking device;
an input by the second system; and
an output by the second system.

19. The computer readable medium of claim 16 comprising instructions for generating the bill based on terms of a rental agreement associated with the rented transport.

20. The computer readable medium of claim 16 comprising instructions for generating the bill based on a location of the rented transport.

21. A system for billing, comprising:
a third party entity;
a toll rental entity that receives a request for service from the third party entity, wherein the request includes at least one of:
a rental agreement number;
a toll fee device identifier;
a start date of the service;
a start time of the service;
an end date of the service;
an end time of the service; and
a toll authority that receives a payment from the toll rental entity for the service.

22. The system of claim 21, wherein the toll authority receives the request for the service.

23. A system for billing, comprising:
a third party entity;
a toll fee device that receives a request for service from the third party entity, wherein the request includes at least one of:
a rental agreement number;
a toll fee device identifier;
a start date of the service;
a start time of the service;
an end date of the service;
an end time of the service; and
a toll data database communicably coupled to the toll fee device, wherein the toll data database is refreshed upon receipt of the request.

24. The system of claim 23, wherein the third party entity receives toll data from the toll data database.

25. The system of claim 23 comprising a toll rental entity which may receive an invalid toll fee device identifier from a toll authority.

26. The system of claim 25, wherein the toll rental entity checks the toll data database for valid toll fee device identifiers.

27. The system of claim 26, wherein if the valid toll fee device identifiers are not found, the toll rental entity informs the toll authority, wherein the toll authority then checks other sources to determine at least one of: an owner, an originator, and an account holder of the toll fee device.

28. The system of claim 25, wherein the toll data database receives toll data from the toll authority.

29. The system of claim 28, wherein the third party entity receives toll data from the toll data database.

30. The system of claim 29, wherein the toll rental entity receives the request from the third party entity.

31. The system of claim 30, wherein the toll authority receives, from the toll rental entity, at least one of:
a payment;
the request; and
the toll data.

32. A method for billing, comprising:
receiving information including at least one of: a direction of travel by a transport, a location of the transport, a price of a toll, a toll gate number, a date, and a time;
sending the received information to a database;
matching the sent information with information related to a rental agreement, wherein the information related to the rental agreement is stored in the database, and wherein the rental agreement covers the rented transport; and
determining a billing amount based on the matched information.
